(19) United States
(12) Patent Application Publication
(10) Pub. No.: US 2007/0028214 A1
(43) Pub. Date: Feb. 1, 2007

(54) METHOD AND SYSTEM FOR CREATING CULTURE-SENSITIVE CONTROLS FOR GLOBAL APPLICATIONS

(76) Inventors: BEI Shu, Shanghai (CN); Xiao Hui Zhu, Shanghai (CN); Hua Gang Huang, Shanghai (CN)

Correspondence Address: IBM CORPORATION;INTELLECTUAL PROPERTY LAW, 11400 BURNET ROAD, AUSTIN, TX, 78758, US

(21) Appl. No.: 11/460,541

(22) Filed: Jul. 27, 2006

(30) Foreign Application Priority Data
Jul. 29, 2005 (CN) 200510088823.5

(51) Int. Cl. G06F 9/44

(52) U.S. Cl. 717/120; 717/104

(57) ABSTRACT

Embodiments of the present invention provide a system and method for dynamically creating a culture-sensitive control for a global application using reusable culture-sensitive components. In one embodiment, a system is provided which comprises a presentation unit, which functions as an interface between the system and the global application's console, to transfer call parameters and user data as well as the creation result of the culture-sensitive control generated based on call parameters and user data between the console and system; a resource management unit for providing relevant culture data of corresponding culture-sensitive components based on the call parameters presented by the presentation unit; and a logic unit for parsing the relevant culture data of the corresponding culture-sensitive components provided by the resource management unit, combining it with the user data, generating the creation result of the culture-sensitive control and providing it to the presentation unit.

### CROSS-REFERENCE TO RELATED APPLICATIONS

This application claims the benefit of priority of Chinese Patent Application No. 200510088823.5 filed on Jul. 29, 2005, and entitled “METHOD AND SYSTEM FOR CREATING CULTURE-SENSITIVE CONTROLS FOR GLOBAL APPLICATIONS” hereby incorporated by reference herein for all purposes.

### BACKGROUND

1. Technical Field

The present invention relates to the development of global applications, more particularly, to a method and system for creating dynamic, user-interactive culture-sensitive controls for global applications.

2. Description of Related Art

Developing application software, especially developing software oriented to the worldwide application marketplace, requires that software adapt to and honor the different cultural expectations of different regions in which the application is being used. It is a well-known fact that an application should provide a friendly “globalized” interface for its customers. For example, the preferred language of the customer in the region is used; date, time, number and currency are formatted according to the culture conventions of the customers in the region, and so on. Presently, almost all the prevalent programming technologies have rich fundamental functions for developing globalized applications. These fundamental functions include: Unicode support, extensive internationalization classes, and a facility for generating single-locale sensitive executable codes. There is, however, a category of culture-sensitive and user-interactive functionalities, referred to as culture-sensitive controls, which are not directly supported by existing programming technologies, but are indispensable to today's global e-business applications. Some examples of such controls are listed below:
Name Input (where people can input and edit their names): the field, order, labels, and honorifics are different across countries;
Address Input (where people can input and edit their addresses): the field, order and labels are different across countries;
Calendar (where people can select a date from a pop-up calendar window): the first day and weekend are different by country, and the dates in the calendar should be arranged by the location of the first day and weekend;
Date Chooser (where people can select Year/Month/Day from three pull-down menus): the date order could be Year-Month-Day, Month-Day-Year and Day-Month-Year according to the cultural conventions of different locales, and the month and day lists are different;
Time Chooser (where people can select time by adjusting hour/minute/second and AM/PM mark from up/down buttons): some countries use 12-hour pattern, some use 24-hour pattern, while others can use both, and the AM/PM marks are different across countries.

These culture-sensitive controls usually appear in the user management system where customers are required to input name, address and birthday. They are also in every scenario where customers need to select a date or time, such as booking air tickets or hotel, arranging meetings, and deciding shipping dates. The common characteristics of these controls are:
1. User-interactive: these controls need user's input to gather the user data;
2. Culture-sensitive: in different locales (a locale is composed of both language and country), these controls have different behaviors and need different culture data;
3. Business logic independent: these controls always appear in the application front-end providing end-users with the interface for inputting information, and the culture-sensitive behavior itself owned by these controls is independent of the application business logic;
4. Application UI (User Interface) dependent: the layout of these controls are dependent on the application UI, and they should match the UI layout of the entire page, such as horizontal layout, vertical layout, width, length, fonts, and styles;
5. Application UI technology dependent: the implementations of these controls are tightly dependent on the UI technology applied in application front-end. For example, the functions for Web and Java standalone applications use completely different UI technologies.

Since these culture-sensitive controls are commonly used by application programs' UI and are not dependent on core business logic, it is desired that these functions be encapsulated as reusable components when developing applications that contain such controls to avoid duplicated development for similar applications. However, because these culture-sensitive controls are also application UI dependent and application UI technology dependent, it's rather hard to abstract them to separate components that can adapt to all similar applications. Therefore, in today's application software development, code with corresponding cultural characteristics has to be individually written for each locale to realize similar functions, although it's rather awkward and the code written is hard to maintain and extend (if more language support is to be added in the future). In addition, such an approach is time-consuming and error-prone for application software developers to write these culture-sensitive functions from scratch especially if they don't have much globalization knowledge.

FIG. 1 shows an example of some culture-sensitive functions implemented in a global application in prior art. As shown in FIG. 1, in one page of the global application, there are culture-sensitive functions such as name input, address input and date chooser that need user input, wherein the area labeled with en_US is the page view of that page for the locale indicated by en_US, while the area labeled with zh_CN is the page view of that page for the locale indicated by zh_CN. It can be seen that the language and format (locale, sequence, label and the honorific) used by the name input, address input and date chooser in the two pages are different. Namely, since the two locales have different cultural convention, same culture-sensitive function in same page of the application should have different languages and formats for the two different locales.

At present, since various existing libraries and programming languages do not provide culture-sensitive standard user controls, to make a global application to be capable of being applied to different locales, its developers have to write respectively for these locales corresponding culture-sensitive functions that conform to the cultural convention of each locale. In addition, application software developers have to write customized codes for each application respectively to realize these common culture-sensitive functions, such as name and address input. Apparently, such work is repetitive, time-consuming and the solution currently employed is self-organized and non-extensible.

FIG. 2 shows a schematic diagram of the process of implementing culture-sensitive functions in developing global application in prior art. As described above, in prior art, since application software developers can not get desired result by directly calling existing programming languages' class library when implementing culture-sensitive functions, they must first call the globalization sub-class library in these class libraries to get the corresponding culture data, then use these culture data to generate codes with culture-sensitive functions, while these codes will be embedded in the application program itself. In the example of date input in FIG. 2, developers must get data such as month name list and date format from globalization sub-class library, then write code to use these data to generate culture-sensitive date input form on the user interface of the application program.

To reduce the burden of global application software developers to write such culture-sensitive functions when developing global applications, a technology is needed to abstract these functions to reusable components, create dynamic, user-interactive culture-sensitive controls for global applications by using the reusable components, provide application software developers with the ability of customization for an applications' special needs, and at the same time provide a flexible architecture for future enhancement.

### BRIEF SUMMARY

A system and method for dynamically creating a culture-sensitive control for a global application by using reusable culture-sensitive components are provided herein. In accordance with one embodiment of the present invention, a system for dynamically creating a culture-sensitive control for a global application is provided which comprises a presentation unit, which functions as an interface between the system and the global application's console, for transferring call parameters and user data as well as the creation result of the culture-sensitive control generated based on the call parameters and user data between the global application's console and the system; a resource management unit for providing relevant culture data of a corresponding culture-sensitive component based on call parameters presented by the presentation unit; and a logic unit for parsing the relevant culture data of the corresponding culture-sensitive component provided by the resource management unit, combining it with the user data, generating the creation result of the culture-sensitive control and providing it to the presentation unit.

The foregoing is a summary and thus contains, by necessity, simplifications, generalizations and omissions of detail; consequently, those skilled in the art will appreciate that the summary is illustrative only and is not intended to be in any way limiting. As will also be apparent to one of skill in the art, the operations disclosed herein may be implemented in a number of ways including implementation in hardware, software, or a combination thereof, and such changes and modifications may be made without departing from this invention and its broader aspects. Other aspects, inventive features, and advantages of the present invention, as defined solely by the claims, will become apparent in the non-limiting detailed description set forth below.

### BRIEF DESCRIPTION OF THE DRAWINGS

It is believed that the above features, advantages and purposes of the invention will be better understood from the following description of the preferred embodiments of the invention taken in conjunction with the accompany drawings, in which:

FIG. 1 shows an example of some culture-sensitive functions implemented in a global application in prior art;

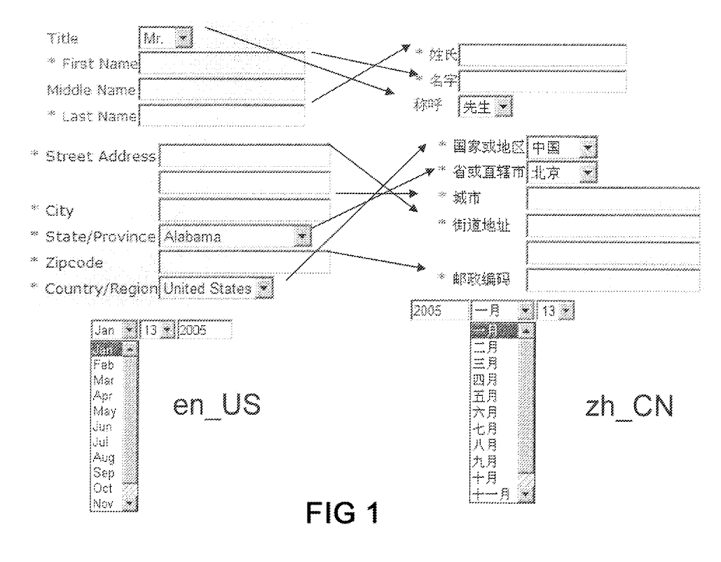

FIG. 2 shows a schematic diagram of the process of implementing culture-sensitive functions in developing global application in prior art;

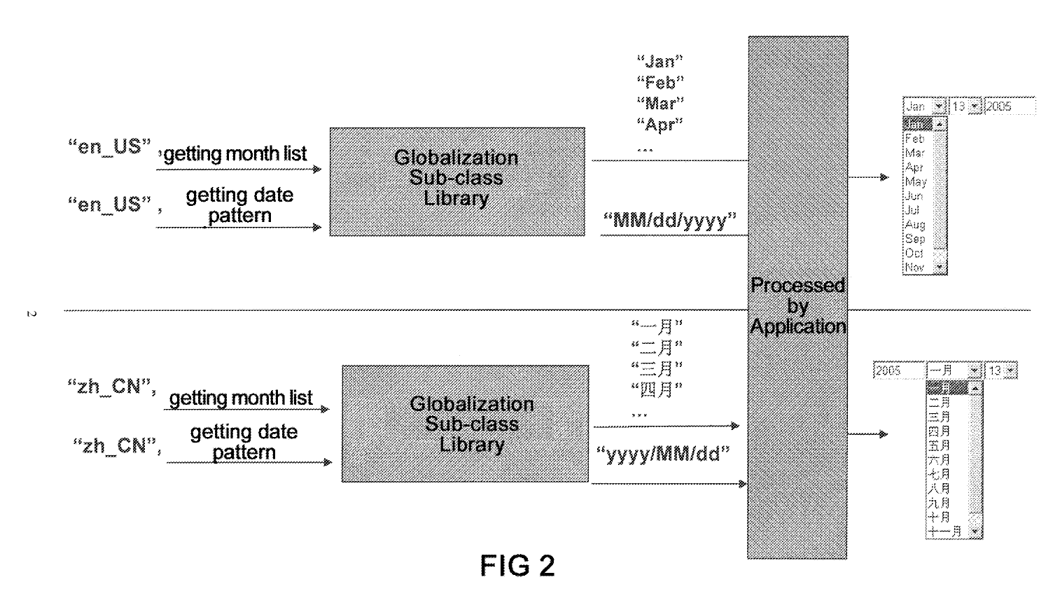

FIG. 3 shows a schematic diagram of the architecture proposed by the invention that abstracts culture-sensitive components in developing global applications and creates dynamic, user-interactive culture-sensitive controls for global applications with these reusable components;

FIG. 4 shows a logic diagram of the system for creating culture-sensitive controls for global applications;

FIG. 5 is a working result example of the system for creating culture-sensitive controls for global applications according to one embodiment of the invention;

FIG. 6 is another working result example for the system of creating culture-sensitive controls for global applications according to one embodiment of the invention;

FIG. 7 is a block diagram of the system for creating culture-sensitive controls for global applications according to one embodiment of the invention;

FIG. 8 is a working flowchart of the system for creating culture-sensitive controls for global applications in FIG. 7; and

FIG. 9 is a flowchart of the method for creating culture-sensitive controls for global applications according to one embodiment of the invention.

The use of the same or similar reference symbols within the accompanying drawings is intended to indicate similar or identical items.

### DETAILED DESCRIPTION

Embodiments of the present invention may be utilized to solve the problem that same culture-sensitive function needs to be written respectively for each different locale during the development of same global application, which is often encountered by global application developers.

To solve the described problem, embodiments of the present invention provide a system and method for creating a culture-sensitive control for a global application which abstracts culture-sensitive functions to various reusable culture-sensitive components managed by locales, and creates dynamic, user-interactive culture-sensitive controls for global applications using these reusable components. Application software developers can insert one or more such culture-sensitive controls into the application software with the system and method of the present invention, thereby significantly reducing the development burden of realizing these culture-sensitive functions.

According to one embodiment of the present invention, there is provided a system for dynamically creating a culture-sensitive control for a global application, comprising: a presentation unit, which functions as an interface between the system and the global application's console, for transferring call parameters and user data as well as a creation result of the culture-sensitive control generated based on the call parameters and user data between the global application's console and the system; a resource management unit for providing relevant culture data of corresponding culture-sensitive components based on the call parameters presented by the presentation unit; and a logic unit for parsing the relevant culture data of corresponding culture-sensitive components provided by the resource management unit, combining it with the user data, and generating the creation result of the culture-sensitive control.

In the described embodiment, the system further comprises a culture data repository for storing the relevant culture data of respective culture-sensitive components for the resource management unit, the relevant culture data of these culture-sensitive components is organized by different locale items and is managed and maintained by the resource management unit.

In the described embodiment, the language and format used by the culture-sensitive components organized by different locale items in the culture data repository conform to the cultural convention of their corresponding locales.

In the described embodiment, the call parameters contain a locale ID and a culture-sensitive control ID, the resource management unit extracts relevant culture data of respective culture-sensitive components under the corresponding locale item from the culture data repository based on the locale ID and the culture-sensitive control ID, and generates a culture data descriptor based on the obtained data, wherein the culture data descriptor is a file or data object that describes the obtained relevant culture data in a format that can be processed by the system.

In the described embodiment, the logic unit processes the culture data descriptor by using the user data to generate a user data descriptor, wherein the user data descriptor is a file or data object that describes the user data and culture data in a format that can be processed by the system.

In the described embodiment, the system further comprises a template repository for storing commonly used template-defining presentation layout information of respective culture-sensitive controls, wherein the call parameters further comprise a template ID, the presentation unit presents the creation result of the culture-sensitive control to the global application's console in a presentation layout defined by a template specified by the template ID.

According to another embodiment of the present invention, there is provided a method for dynamically creating a culture-sensitive control for a global application, the method comprising managing and maintaining, by different locale items, relevant culture data of associated culture-sensitive components to generate the culture-sensitive control; extracting relevant culture data of corresponding culture-sensitive components under a corresponding locale item based on a locale ID and a control ID from a console of the global application; combining the relevant culture data of the corresponding culture-sensitive components with user data from the console to generate a creation result of the culture-sensitive control and presenting it to the console.

Several advantages of the present invention include:
1. Embodiments of the present invention abstract culture-sensitive and user-interactive functions to various reusable culture-sensitive components, and create a dynamic, user-interactive, culture-sensitive control for a global application with these reusable components.
2. Embodiments of the present invention enable application software developers to realize culture-sensitive controls needed using various components that have already been defined, thereby significantly reducing software development burdens.
3. Embodiments of the present invention eliminate dependencies on the culture-sensitive controls of other technologies which can provide cost-effective customization/extension capabilities.
4. Embodiments of the present invention maintain and manage each culture-sensitive component by locale, so that it is simpler to update and enhance the system.

To solve the problem of repetitively writing culture-sensitive functions to simplify the development of global applications, the present invention abstracts the culture-sensitive functions commonly used during the development of global applications as reusable standalone components that are applicable to all similar global applications.

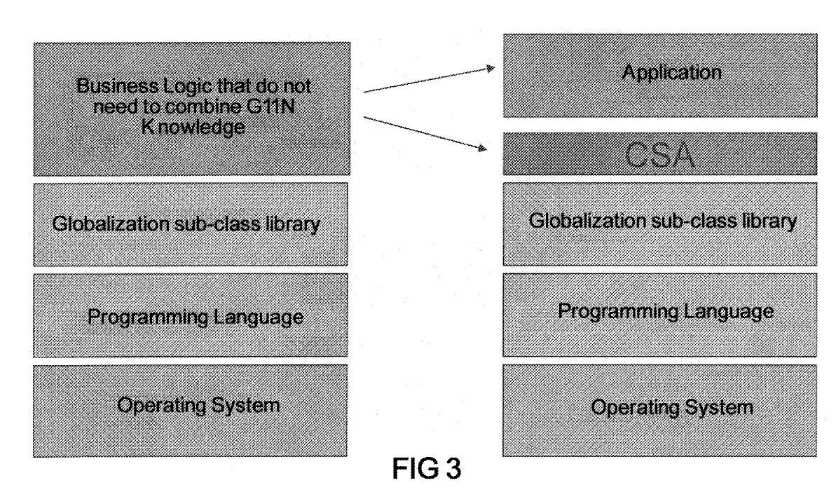

FIG. 3 shows a schematic diagram of the architecture proposed by the invention that abstracts culture-sensitive components in developing global applications and creates dynamic, user-interactive culture-sensitive controls for global applications with these reusable components. As shown in FIG. 3, since the culture-sensitive functions are independent of the global application's core business logic, the present invention, on the basis of the architecture of the global application development in prior art (left side), abstracts common culture-sensitive functions to reusable components that are applicable to the development of all similar global applications and creates dynamic, user-interactive culture-sensitive controls for global applications with these reusable components. In the present invention, such functions are separated from application business logic and are used as an underlying layer that is the lower layer of the global application and supports the global application development. In the invention, this layer is referred to as a Culture Sensitive Asset (CSA) layer.

As described above, the CSA layer contains common culture-sensitive components, such as name input component, address input component, popup calendar, date chooser and time chooser etc.

To apply these components of the CSA layer to global application development, a system of creating culture-sensitive controls for global applications is proposed according to one aspect of the invention.

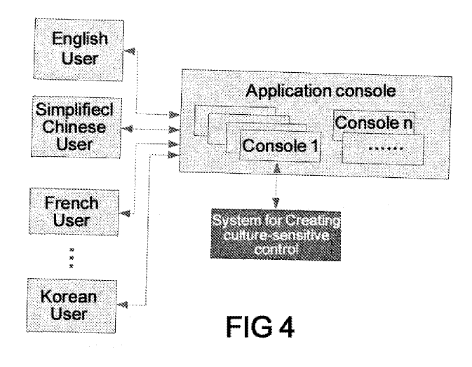

FIG. 4 shows a logic diagram of the system for creating culture-sensitive controls for global applications according to one aspect of the invention. As shown in FIG. 4, the system of the invention interacts with the global application console through the interface provided by the system. The global application console controls a certain global application and is located at server side. Namely, the global application console controls the application issued to worldwide and the access from a client to the application, which is the application user interface through which an end-user interacts with that global application. Based on the request to the console content that is displayed in its preferred language from a worldwide client, the global application console invokes the system of the invention to generate the corresponding culture-sensitive control and present the globalized output to the client. Therefore, the function of the invention is to generate different forms of culture-sensitive control for the terminal that has different language and cultural convention according to the request of the end-user under the invoking of the global application console.

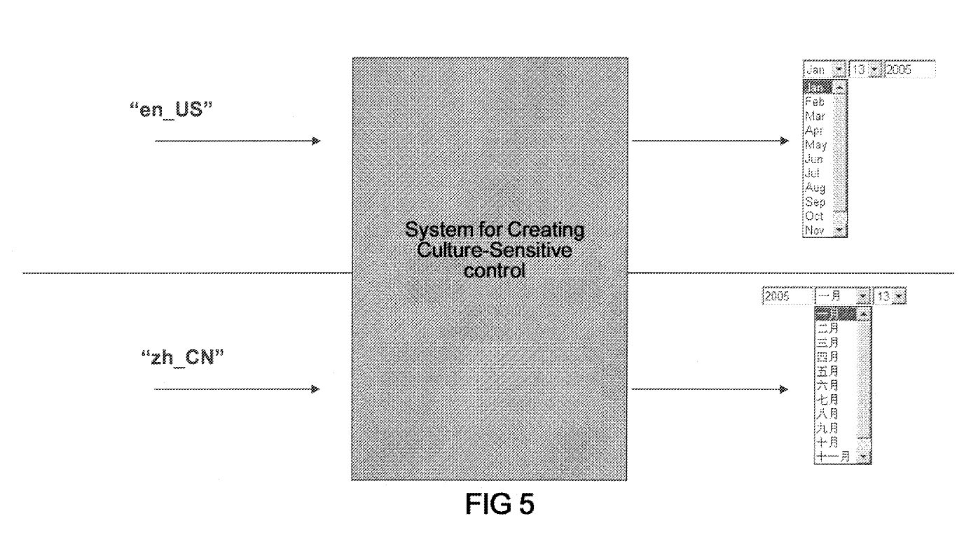

FIG. 5 is a working result example of the system for creating culture-sensitive controls for global applications according to one embodiment of the invention. As shown in FIG. 5, the system will generate the culture-sensitive control that conforms to the cultural convention of different locales according to different locale ID. In the present invention, the requested culture-sensitive control corresponding to the locale is generated based on a locale ID, the locale ID used in the invention comprises two aspects, namely language and country, that is, a locale ID should indicate the language used by the locale and the country related to the locale. For instance, the form of a locale ID is the en_US (English-United States) and zh_CN (Chinese-China) shown in FIG. 5. In case of the example in FIG. 5, the system of the invention generates a date chooser that uses English and conforms to American's convention based on the locale ID en_US, namely, the sequence of year, month and date in the date chooser is a sequence that conforms to American's convention. While for locale ID zh_CN, the system for the invention generates a date chooser that uses Chinese and conforms to Chinese date writing convention. Thus, it can be seen that the system for creating culture-sensitive control for global applications according to one aspect of the present invention will dynamically generate different culture-sensitive control instances for user to interact based on different locale ID.

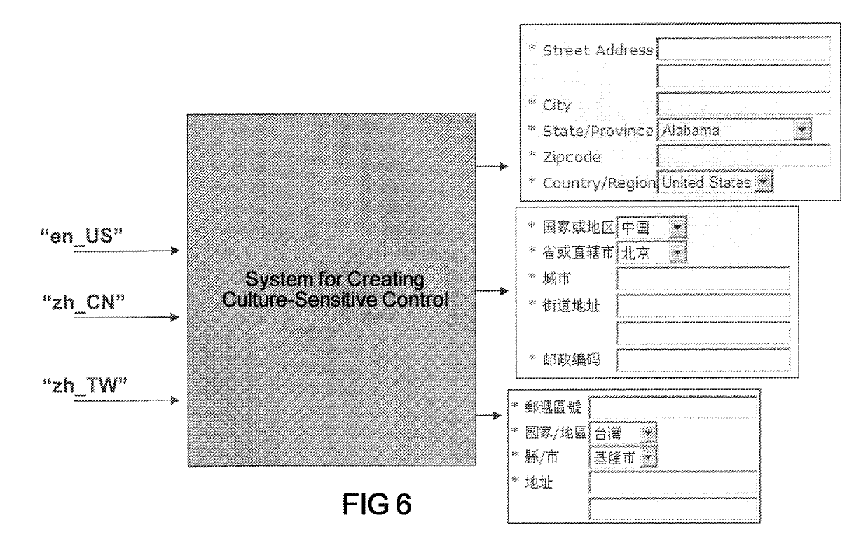

FIG. 6 is another working result example of the system for creating culture-sensitive controls for global applications according to one embodiment of the invention. In this example, the system creates address input controls based on the request coming from different end-users. As shown in FIG. 6, based on locale ID en_US, the system creates an address input control that uses English and the address sequence of which is in a sequence that is gradually detailed from bottom to top. While for locale ID zh_CN, the system creates an address input control that uses Chinese and the address sequence of which is in a sequence that is gradually detailed from top to bottom. While for locale ID zh_TW, the system creates an address input control that uses Traditional Chinese and conforms to address writing convention in Taiwan.

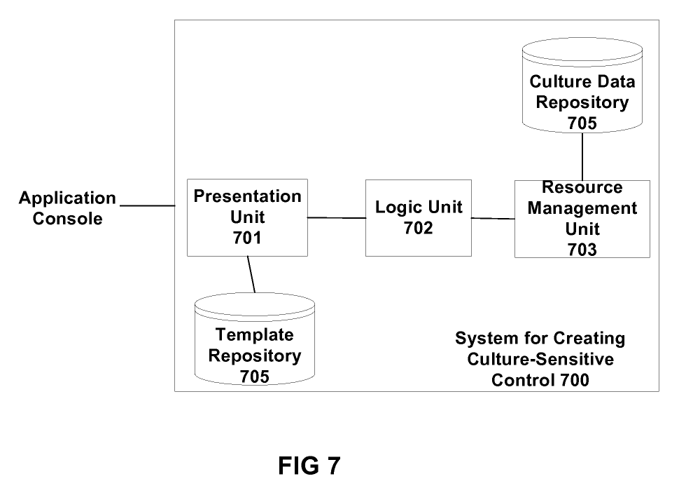

FIG. 7 is a block diagram of the system for creating culture-sensitive controls for global applications according to one embodiment of the invention. As shown in FIG. 7, the system 700 for creating culture-sensitive controls of the invention comprises a presentation unit 701, a logic unit 702, a resource management unit 703, a culture data repository 704 and a template repository 705.

The presentation unit 701, which functions as an interface between the system 700 and the global application's console, is used to transfer call parameters and user data as well as the creation result of the culture-sensitive control created based on the call parameters and user data between the global application's console and the system 700. Wherein the call parameter contains a locale ID, a culture-sensitive control ID and a template ID. Locale ID, such as en_US or zh_CN, is used to indicate the locale of the end-user that requests the culture-sensitive control, and to indicate the language used by the user and the user's country. The culture-sensitive control ID indicates which type of culture-sensitive control is to be created at this time. The template ID indicates in which presentation layout the culture-sensitive control created at this time will be presented to an application.

The resource management unit 703 extracts the relevant culture data of the corresponding culture-sensitive component of the corresponding locale from the culture data repository 704 based on the locale ID and culture-sensitive control ID transferred by the presentation unit 701, and transfers the culture data to the logic unit 702.

The logic unit 702 parses the relevant culture data of the corresponding culture-sensitive component provided by the resource management unit 703, combines it with the user data presented by the presentation unit 701, and generates the creation result of the culture-sensitive control. Wherein, the user data is the application data inputted by an end-user for a certain culture-sensitive control, for example, the user data can be name, address or current date and time inputted by the end-user. In addition, for the creation result of the culture-sensitive control generated by logic unit 702, the presentation unit 701 extracts specified templates from the template repository 705 based on a template ID and presents the result to the global application console in a presentation layout defined by the template to generate globalized output at the global application console.

The culture data repository 704 stores relevant culture data of various culture-sensitive components for the system, these culture data contains information on the various culture-sensitive components for different locales, such as name label, sequence, field, date or time modes etc. The relevant culture data of these culture-sensitive components are organized by different locale items, and are managed and maintained by the resource management unit 703. The language and format used by the culture-sensitive components organized by different locale items in the culture data repository 704 should conform to the cultural convention of its corresponding locale. In the present embodiment, the culture-sensitive control that could be created for global application console through these reusable components include name input control, address input control, calendar, date chooser and time chooser etc. For example, the name input control can generate a name edit form whose field, label and sequence conforms to the cultural convention of the specified locale; the popup calendar control can generate a popup calendar window whose first day and weekend conforms to the cultural convention of the specified locale.

Further, the culture data repository 704 organizes culture-sensitive components by different locales, so that it becomes simple to update the repository. When a new locale is to be added, the only thing need to do is to replicate a culture data definition and create another culture data definition for the same structure.

The template repository 705 stores the commonly used template that defines the presentation layout information of respective culture-sensitive controls. Wherein, the presentation layout information of respective culture-sensitive controls contains vertical and horizontal, font, style, width and length etc. Each template defines one layout. These templates could be customized and created by the system administrator.

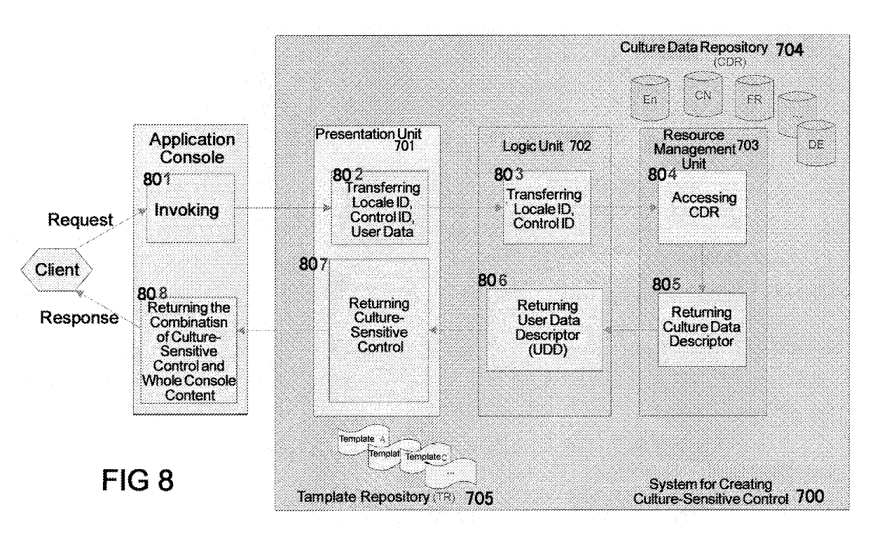

FIG. 8 is a working flow chart of the system 700 of creating culture-sensitive control for global applications of the above embodiment.

As shown in FIG. 8, the working flow begins with a user requests to the global application console for console content to be displayed, the content contains some culture-sensitive functions.

Then, (process block 801) in addition to its own corresponding process, the application console also invokes system 700 through locale ID, control ID, user data and template ID that corresponding to the user.

At process block 802, the presentation unit 701 of the system 700 receives the above call parameters from the application console, and transfers the locale ID, control ID and user data therein to the logic unit 702.

At process block 803, the logic unit 702 transfers the locale ID and control ID to the resource management unit 703.

At process block 804, the resource management unit 703 accesses the culture data repository 704 based on the locale ID and control ID to get the relevant culture data of the corresponding culture-sensitive component under the corresponding locale.

At process block 805, the resource management unit 703 generates a culture data descriptor (CDD) based on the obtained data and returns it to the logic unit 702. Wherein, the culture data descriptor is a file that describes the obtained relevant culture data in a format that can be processed by system 700. In the present embodiment, the CDD could also be constructed as a data object that describes the above data.

At process block 806, the logic unit 702 processes the CDD by using the user data to generate a user data descriptor (UDD), or referred to as the creation result of the culture-sensitive control, and returns it to the presentation unit 701. Wherein, the user data descriptor is a file or data object that describes the user data and culture data in a format that can be processed by system 700.

At process block 807, the presentation unit 701 processes the UDD by using the template specified by the template ID to generate a culture-sensitive control and return it to the application console that invokes system 700. Wherein, the culture-sensitive control is the culture-sensitive control of system 700 that combines the user data, culture data and layout data.

Then, at process block 808, the application console combines the culture-sensitive control of system 700 with its own entire console content and presents it to the user that requests the console content.

In addition, global application developers can add new presentation layout definition in the template repository 705 or modify the presentation layout definition in an existing template to realize customized presentation layout for the culture-sensitive control.

In addition, in a particular implementation, the system 700 can be embedded into the application console as one or more plug-ins of the application console, and be directly invoked by the application console through the application programming interface (API) provided by the system 700.

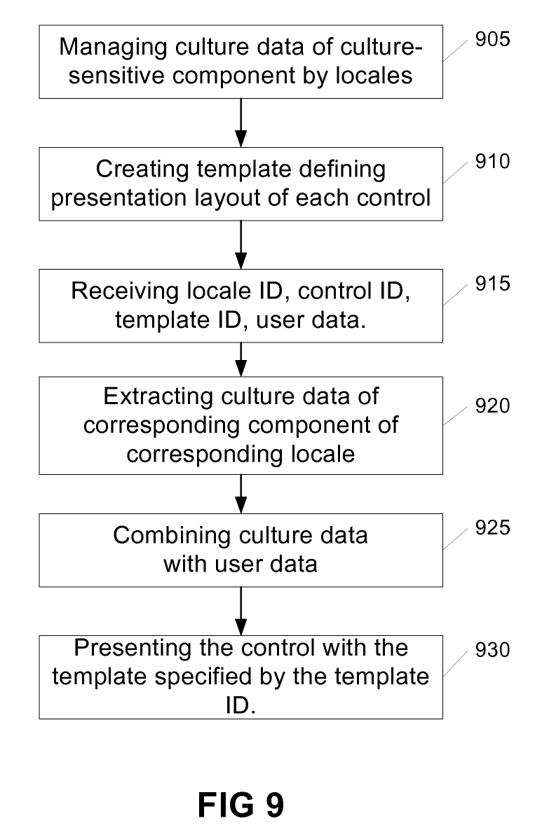

According to another aspect of the invention, there is proposed a method for creating culture-sensitive controls during the development of global applications. FIG. 9 is a flowchart of the method for creating culture-sensitive controls for global applications according to one embodiment of the invention.

As shown in FIG. 9, in the method, first at process block 905, various reusable culture-sensitive components are abstracted for global applications, and the relevant culture data of each culture-sensitive component is managed and maintained in a repository by different locale items. The culture-sensitive components in each locale conform to the cultural convention of the locale it belongs to in terms of language and format. In this operation, a locale ID is also allocated to each locale, the locale ID implies two aspects of information, namely, the language used in the locale and the country to which the locale belongs, such as zh_CN and en_US.

At process block 910, various templates for defining the presentation layout of each culture-sensitive control are created, and a template ID is specified for each template.

At process block 915, locale ID, control ID, template ID and user data from global application console are received.

At process block 920, the relevant culture data of the corresponding culture-sensitive component under the corresponding locale item is extracted from the repository based on the locale ID and control ID.

At process block 925, the relevant culture data of the corresponding culture-sensitive component extracted at process block 920 and the user data coming from the global application console are combined as the creation result of the culture-sensitive control.

At process block 930, the creation result of the control in process block 925 is presented to the global application console with the template specified by the template ID.

Wherein, process block 920 may further comprise: generating a culture data descriptor based on the obtained relevant culture data, wherein the culture data descriptor is a file or data object that describes the obtained relevant culture data in a format that can be processed by the system that applies the method.

Wherein, process block 925 may further comprise: processing said culture data descriptor by using said user data to generate a user data descriptor, wherein the user data descriptor is a file or data object that describes said user data and culture data in a format that can be processed by the system that applies the method.

Furthermore, in the method, it may further comprise the operation of adding a new locale, in that portion of the process, first a new locale ID is defined, then the relevant culture data of each culture-sensitive component under the existing locale ID is replicated to the newly defined locale item, and the relevant culture data under the newly defined locale item is modified so as to make the language and format used by each component conform to the cultural convention of that locale.

Hereinbefore, the system and method for creating culture-sensitive controls during global application development according to the present invention is described in conjunction with the embodiments. It should be noted that these embodiments are only illustrative and various modifications can be made by those skilled in the art on the basis of these embodiments.

What is claimed is:

1. A system for dynamically creating a culture-sensitive control for a global application, the system comprising:
a presentation unit, which functions as an interface between the system and a console of the global application, to transfer call parameters and user data as well as a creation result of the culture-sensitive control generated based on the call parameters and user data between the console and the system;
a resource management unit to provide relevant culture data of a corresponding culture-sensitive component based on call parameters presented by the presentation unit; and
a logic unit to parse the relevant culture data of the corresponding culture-sensitive component provided by the resource management unit, to combine the relevant culture data with the user data, to generate the creation result of the culture-sensitive control and to provide the creation result to the presentation unit.

2. The system of claim 1, further comprising:
a culture data repository to store the relevant culture data of associated culture-sensitive components, wherein the relevant culture data of associated culture-sensitive components is organized by different locale items and is managed and maintained by the resource management unit.

3. The system of claim 2, wherein the language and format used by each of the culture-sensitive components organized by different locale items in the culture data repository conforms to a cultural convention of a corresponding locale.

4. The system of claim 2, wherein each of the culture-sensitive components organized by different locale items in the culture data repository comprise one or more of a name input component, an address input component, a calendar, a date chooser and a time chooser.

5. The system of claim 2, wherein the call parameters comprise a locale ID and a culture-sensitive control ID.

6. The system of claim 5, wherein the resource management unit extracts relevant culture data of associated culture-sensitive components under a corresponding locale item from the culture data repository based on the locale ID and the culture-sensitive control ID, and generates a culture data descriptor based on extracted relevant culture data, wherein the culture data descriptor is a file or data object that describes the extracted relevant culture data in a format that can be processed by the system.

7. The system of claim 6, wherein the logic unit processes the culture data descriptor using said user data to generate a user data descriptor, wherein the user data descriptor is a file or data object that describes the user data and culture data in a format that can be processed by the system.

8. The system of claim 1, further comprising:
a template repository to store commonly-used template-defining presentation layout information of respective culture-sensitive controls.

9. The system of claim 8, wherein the call parameters further comprise a template ID, said presentation unit presents the creation result of the culture-sensitive control to the console in a presentation layout defined by a template specified by the template ID.

10. A method for dynamically creating a culture-sensitive control for a global application, the method comprising:
managing and maintaining, by different locale items, relevant culture data of associated culture-sensitive components to generate the culture-sensitive control;
extracting relevant culture data of corresponding culture-sensitive components under a corresponding locale item based on a locale ID and a control ID from a console of the global application;
combining the relevant culture data of the corresponding culture-sensitive components with the user data from the console to generate a creation result of the culture-sensitive control and presenting it to the console.

11. The method of claim 10, wherein extracting relevant culture data of corresponding culture-sensitive components under the corresponding locale item based on the locale ID and control ID from the console further comprises: generating a culture data descriptor based on extracted relevant culture data, wherein the culture data descriptor is a file or data object that describes the extracted relevant culture data in a format that can be processed by a system which implements the method.

12. The method of claim 11, wherein combining the relevant culture data of the corresponding culture-sensitive components with user data from the console further comprises: processing the culture data descriptor using the user data to generate a user data descriptor, wherein the user data descriptor is a file or data object that describes the user data and culture data in a format that can be processed by the system.

13. The method of claim 10, wherein managing and maintaining relevant culture data of associated culture-sensitive components further comprises:
causing languages and formats used by each of the associated culture-sensitive components to conform to a cultural convention of a corresponding locale.

14. The method of claim 10, further comprising:
defining a new locale ID;
replicating the relevant culture data of associated culture-sensitive components under an existing locale ID to the new locale ID; and
modifying the relevant culture data under the new locale ID so as to make a language and format used by each culture-sensitive component conform to a cultural convention of a locale associated with the new locale ID.

15. The method of claim 10, further comprising:
creating templates to define the presentation layout of respective culture-sensitive controls; and
presenting the creation result of the culture-sensitive control to the console in a presentation layout defined by a corresponding template based on a template ID from the console.
